(19) United States
(12) Patent Application Publication
(10) Pub. No.: US 2023/0264978 A1
(43) Pub. Date: Aug. 24, 2023

(54) WATER TREATMENT SYSTEM, WATER TREATMENT METHOD, AND INFORMATION PROCESSING APPARATUS

(71) Applicant: Yokogawa Electric Corporation, Tokyo (JP)

(72) Inventor: Yasuhiro MATSUI, Tokyo (JP)

(73) Assignee: Yokogawa Electric Corporation, Tokyo (JP)

(21) Appl. No.: 18/171,336

(22) Filed: Feb. 18, 2023

(30) Foreign Application Priority Data
Feb. 21, 2022 (JP) 2022-025013

(51) Int. Cl. C02F 1/00; G05B 19/042

(52) U.S. Cl. CPC C02F 1/008; G05B 19/042; C02F 2209/006; G05B 2219/2605

(57) ABSTRACT

A water treatment system includes an equipment system including each water treatment device that executes a water treatment process and a control apparatus that controls each water treatment device, and a management system including a management apparatus that determines a control content of the water treatment process by using a virtual system obtained by virtualizing each water treatment device and controls the water treatment process of the equipment system based on the control content via the control apparatus of the equipment system.

### CROSS-REFERENCE TO RELATED APPLICATION

The present application claims priority to and incorporates by reference the entire contents of Japanese Patent Application No. 2022-025013 filed in Japan on Feb. 21, 2022.

### BACKGROUND OF THE INVENTION

### Field of the Invention

The present invention relates to a water treatment system, a water treatment method, and an information processing apparatus.

### Description of the Related Art

A water treatment system used in a water purification plant and the like is configured by a combination of systems (level 0) having four types of functions that directly act on water not to be treated. Note that the devices that execute the four types of functions include: a device that executes treatment of physically filtering water (membrane); a device that executes treatment of chemically oxidizing or disinfecting water (UV/Cl/Ozone); a device that controls water conveyance such as a pipe, a pump, and a valve (mechanical component); and a device including a measurement device and software necessary for controlling a water quality, a water amount, a water temperature, a water pressure, and the like (control H&S).

In such a water treatment system, safe operation is performed by executing various commands from a programmable logic controller (PLC) to each of the above-described devices located at a lower level by a logic in control units using the PLC located at a higher level than each of the devices.
Patent Literature 1: JP 2020-025943 A
Patent Literature 2: JP 2020-065964 A
Patent Literature 3: JP 2019-010614 A

### SUMMARY OF THE INVENTION

According to an aspect of an embodiment, a water treatment system includes an equipment system including each water treatment device that executes a water treatment process and a control apparatus that controls each water treatment device, and a management system including a management apparatus that determines a control content of the water treatment process by using a virtual system obtained by virtualizing each water treatment device and controls the water treatment process of the equipment system based on the control content via the control apparatus of the equipment system.

According to an aspect of an embodiment, a water treatment method to be executed by a water treatment system includes an equipment system and a management system. The water treatment method includes executing operation control of each water treatment device that executes a water treatment process, using a control apparatus of the equipment system, determining a control content of the water treatment process by using a virtual system obtained by virtualizing each water treatment device, and controlling the water treatment process of the equipment system based on the control content via the control apparatus of the equipment system, using a management apparatus of the management system.

According to an aspect of an embodiment, an information processing apparatus includes a controller that generates a virtual system obtained by virtualizing each water treatment device that executes a water treatment process in an equipment system, determines a control content of the water treatment process by using the virtual system, and controls the water treatment process of the equipment system based on the control content via a control apparatus that controls each water treatment device that executes the water treatment process in the equipment system.

### BRIEF DESCRIPTION OF THE DRAWINGS

FIG. 1 illustrates an overall configuration of a water treatment system according to a first embodiment;

FIG. 2 illustrates the architecture of a water treatment system according to reference technology;

FIG. 3 is a functional block diagram illustrating a functional configuration of the water treatment system according to the first embodiment;

FIG. 4 is a flowchart illustrating a flow of processing executed by an equipment system;

FIG. 5 is a flowchart illustrating a flow of processing executed by a management system;

FIG. 6 illustrates the architecture of a water treatment system according to a second embodiment;

FIG. 7 illustrates the architecture of a water treatment system according to a third embodiment; and

FIG. 8 illustrates an example of a hardware configuration.

### DETAILED DESCRIPTION OF THE PREFERRED EMBODIMENTS

By the way, in recent water treatment systems, operation control using artificial intelligence (AI) has been achieved. For example, in the operation control using the AI, terminal devices, which are systems of a level 0, are put together in stages gradually to a higher level of system constitutively and as input/output data. Finally, an AI engine (machine learning model) simulates human thought, and derives an optimized solution. A command is transmitted to each device in accordance with the solution.

The above-described water treatment system is, however, configured by a level 1, a level 2, and the other lower levels, and controlled by a sequence control using the PLC. PID (P: proportion, I: integration, and D: differentiation) control is commonly used as the sequence control. In this case, an operation value corresponding to a load encountered by a system can be given, and an order to interrupt operation and avoid a trouble can be executed. In contrast, it cannot be said that optimal automated operation has been achieved since the design does not consider automated operation using AI.

An object of the present invention is to achieve optimal automated operation of a water treatment system.

Embodiments of a water treatment system, a water treatment method, and an information processing apparatus disclosed in the present application will be described in detail below with reference to the drawings. Note that the invention is not limited by the embodiments. Furthermore, the same elements are denoted by the same reference signs, and redundant description will be appropriately omitted. The embodiments can be appropriately combined within a range without inconsistency.

### First Embodiment

Overall Configuration (Architecture)

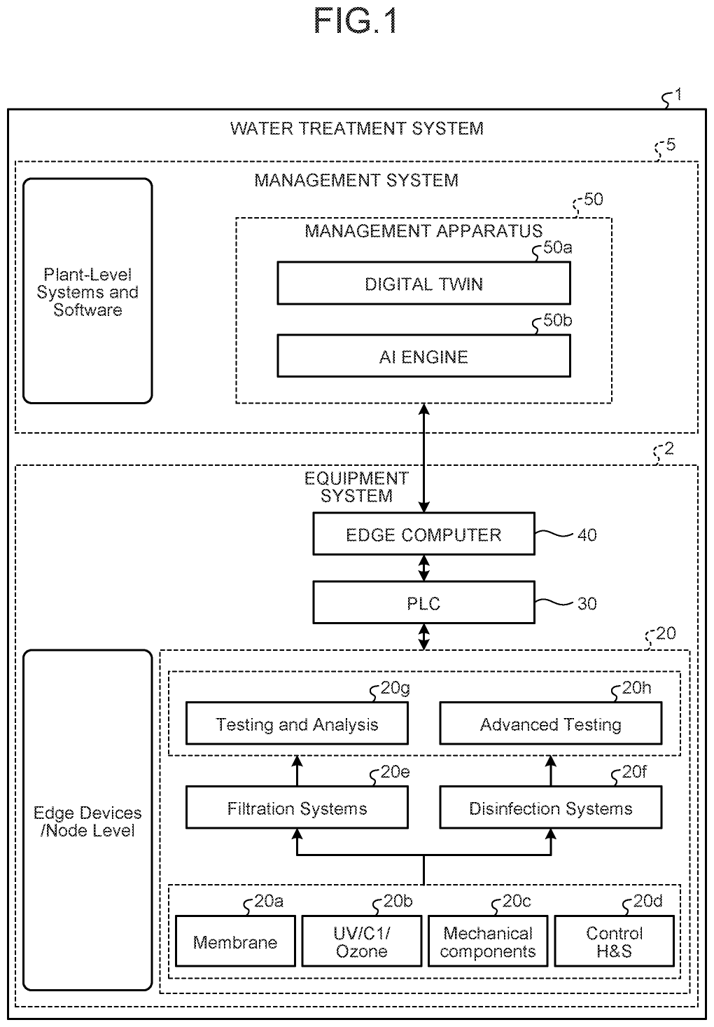

FIG. 1 illustrates an overall configuration of a water treatment system according to a first embodiment. A water treatment system 1 in FIG. 1 is one example of a system that executes advanced water treatment and generates drinking water from wastewater such as sewage and rainwater. The water treatment system 1 is roughly classified into two categories. One is a management system 5 corresponding to plant-level-system and software, and the other is an equipment system 2 corresponding to edge device/node level constituting actual equipment (actual system).

The equipment system 2 includes each water treatment device that executes a water treatment process, and is connected to the management system 5 via a network N. Note that, various networks, such as a dedicated line, a local area network (LAN), a virtual local area network (VLAN), and the Internet can be adopted as the network N.

The equipment system 2 includes a water treatment device group 20, a PLC 30, and an edge computer 40. The water treatment device group 20 has edge devices of a node level. Here, the edge devices of a node level include membranes 20a, a UV/Cl/Ozone 20b, mechanical components 20c, control H&S 20d, filtration systems 20e, disinfection systems 20f, testing and analysis 20g, and an advanced testing 20h. Note that these devices are modularized, and can be controlled for each device.

The membranes 20a are devices that execute treatment of physically filtering water. The UV/Cl/Ozone 20b is a device that executes treatment of performing chemical accelerated oxidation or disinfection on water. The mechanical components 20c are devices such as pipes, pumps, and valves for controlling water conveyance. The control H&S 20d is a device including a measurement device and software necessary for controlling water quality, a water amount, water pressure, water temperature, and the like.

The filtration systems 20e is a device (system) that is configured by any combination of the above-described devices 20a to 20d and that filters water. The disinfection systems 20f are devices that are configured by any combination of the devices 20a to 20d, and that executes disinfection on water by using ultraviolet rays, heat, and the like. The testing and analysis 20g is a device that executes general testing and analysis of pH, electric conductivity, turbidity, water temperature, ultraviolet absorbance, chemical oxygen demand (COD), nitrogen (ammonia nitrogen, nitrate nitrogen, and total nitrogen), and the like, whereas the filtration systems 20e and the disinfection system 20f are devices (systems) that perform physical or chemical water treatment or a water treatment process thereof. The testing and analysis 20g has functions of calculation related to mechanical process management (e.g., on/off of pump and open/close of valve) and operation quality management (e.g., water amount, water pressure, and water quality) and transmission and transfer of an analog or digital signal. The advanced testing 20h is a device that executes advanced testing and analysis, such as polymerase chain reaction (PCR), total organic carbon (TOC), and adenosine tri-phosphate (ATP), on water that has been subjected to filtration or disinfection or both thereof by the filtration system 20e or the disinfection systems 20f or both thereof. The advanced testing 20h has functions of calculation related to management of water quality safe for a human body in operation quality management or the transmission and transfer of an analog or digital signal.

The PLC 30 is one example of a computer that performs the above-described sequence control on each of the devices of a level 0, a level 1, a level 2, and the other lower levels. Furthermore, the PLC 30 executes various commands to each water treatment device in accordance with an instruction from the edge computer 40 located at a higher level.

The edge computer 40 executes operation control of the water treatment process in the equipment system 2. For example, the edge computer 40 receives data on a control status, the control contents, a control result, a treatment status, and the like of the water treatment process from the PLC 30. The edge computer 40 executes simulation using the data and prediction through a machine learning model using the data. The edge computer 40 acquires a result of state prediction of the water treatment process and the like. Then, the edge computer 40 notifies the PLC 30 of the control contents in order to, for example, improve the water treatment process, improve the quality, reduce costs, and adjust a production amount by using the result of state prediction of the water treatment process.

The management system 5 is one example of a computer that controls the water treatment process by controlling the entire equipment system 2, and includes a plant-level of system and software. The management system 5 includes a management apparatus 50. The management apparatus 50 includes a digital twin 50a and an AI engine 50b. The digital twin 50a generates a virtual module (virtual system) obtained by simulating a system configured at a level of actual equipment. The AI engine 50b operates the digital twin 50a, and controls the equipment system 2, which is the actual equipment. Note that the management system 5 can be implemented by a physical machine including a memory and a processor, cloud computing, and the like. The management apparatus 50 can also be implemented by a physical machine, or can be implemented by a virtual machine, a container, and the like using virtual technology.

The digital twin 50a collects various pieces of information from the equipment system 2 and each apparatus in physical space, and reproduces the physical space in virtual space by using the various pieces of collected information. That is, the digital twin 50a virtually constitutes a virtual system that simulates the same variation as that of the equipment system 2, which is actual equipment. The virtual system simulated by the digital twin 50a includes elements of each water treatment device and a virtual terminal device or a virtual module obtained by combining the elements. The virtual module includes a virtual water treatment device corresponding to each water treatment device of the equipment system 2, which is actual equipment.

Furthermore, on the virtual system, it is possible to set and update a parameter capable of directly or indirectly calculating the causal relation between input and output to and from the virtual terminal device or the virtual module based on preliminarily collected data on actual equipment and data sequentially transmitted from the actual equipment. The AI engine 50b to be described later sets and updates the parameter.

Note that the digital twin 50a can also form a virtual system by freely combining virtual water treatment devices of a module or virtual modules.

In relation to the virtual system on the digital twin 50a, the AI engine 50b can derive a virtual operation condition optimal for various environments and calculate an input/output value by collating the virtual module with not only a configuration obtained by simulating the actual equipment but a module including individual virtual water treatment devices. Then, the AI engine 50b outputs the optimal virtual operation condition and the input/output value to an administrator and the like, or notifies the edge computer 40 to update the parameter.

Furthermore, the AI engine 50b performs simulation on the virtual system for sudden variation on the virtual system implemented by the digital twin 50a, and identifies an optimal system configuration. Then, the AI engine 50b outputs a change to the optimal system configuration to the administrator and the like, and updates a parameter used by the edge computer 40 for simulation and the like.

Furthermore, the AI engine 50b can also use, for example, a machine learning model using deep learning and the like. Note that the management apparatus 50 may be implemented by a cloud system, or may be disposed in a module. The management apparatus 50 may have a function of displaying a schematic diagram representing a configuration of a virtual system, a schematic diagram representing a configuration of an actual system, and input/output values and parameters of each water treatment device, each module, each virtual water treatment device, and each water treatment module.

### DESCRIPTION OF REFERENCE TECHNOLOGY AND PROBLEMS

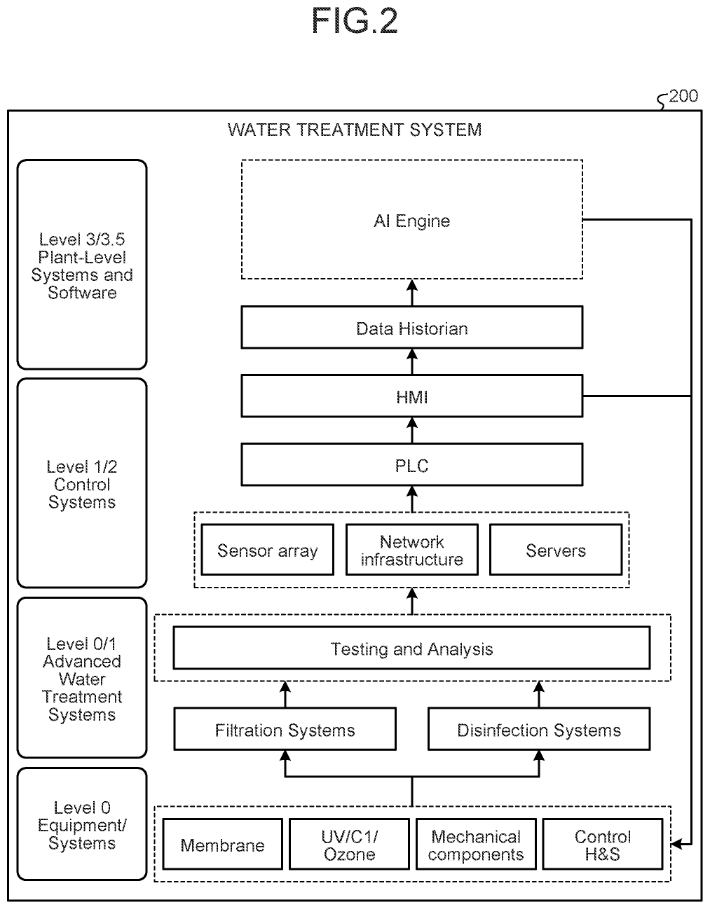

Here, a commonly used water treatment system will be described as reference technology. FIG. 2 illustrates the architecture of a water treatment system 200 according to the reference technology. As illustrated in FIG. 2, the water treatment system 200 such as a water purification plant includes apparatuses and systems of a level 0, advanced water treatment purification systems of the level 0 and a level 1, control systems of the level 1 and a level 2, and plant-level of systems and software of a level 3 and a level 3.5.

In order to control the entire system in accordance with water to be treated, an installation environment, and a purpose of treatment, the water treatment system 200 as described above is constructed in configuration in which the systems of the level 0 are combined and modularized as systems of the level 1 and the level 2 such as the filtration systems and the disinfection systems.

Furthermore, in the water treatment system 200, testing and analysis are performed on the modularized systems of the level 0 or systems of the level 0 and the level 1. The systems of the level 1 and the level 2, which are higher level of systems, include a sensor array, network infrastructure, and a server for controlling transmission and reception of data, and thereby receive pieces of data of testing and analysis executed by the modularized system of the level 0 or the systems of the level 0 and the level 1.

Moreover, the systems of the level 1 and the level 2 include the PLC and a human machine interface (EMI). In the PLC, functions of the level 1 and the level 2 are integrated. The HMI is used for putting together pieces of information collected and transmitted by the PLC and manually operating the entire systems.

In recent years, further stabilized water treatment systems have been operated by further evolving human control via the HMI and introducing a system mounted with an artificial intelligence (AI) engine using machine learning (ML) as the systems of the level 3 and the level 3.5 of much higher levels. In this case, data historian is provided in interfaces between the systems of the level 1 and the level 2 and the systems of the level 3 and the level 3.5. Control of the entire water treatment system by AI instead of a human has been achieved by causing the AI to learn control that has relied on human experiences via the data historian.

As described above, terminal devices (system of level 0) of the water treatment system 200, which is reference technology, are put together in stages gradually to a higher level of system constitutively and as input/output data. In the water treatment system 200, finally, an AI engine derives an optimized solution by simulating human thought, and sends a command to each device (system of level 0) by using the solution.

The water treatment system 200 as described above, however, includes systems of the level 1, the level 2, and the other lower levels. Furthermore, these systems are not designed based on an idea of automated operation using AI. Before development of AI by ML, hierarchical systems obtained by putting together complicated systems in stages have been used so that a computer or a human can manage the systems. That is, a signal and behavior of a device of the level 0 of a terminal is received so that grasp and management of a state can be performed by a human or data analysis, and items to be managed are narrowed down. Control measures using feedback and the like have been proposed. In order to perform optimization by AI using ML in the entire water treatment system, a control loop for each hierarchy needs to be optimized. Now, each device is not comprehensively controlled, and overall optimization has been not achieved.

Moreover, due to the hierarchization, the optimization of the entire water treatment system in consideration of a combination of a low level of systems, that is, devices of the level 0 and expansion and replacement across hierarchies of devices is far from completion. Furthermore, also from the viewpoint of cooperation of a plurality of water treatment systems, data used for AI to learn and analyze operation records in other facilities is not sufficiently accumulated since data diversion between devices is difficult. Although apparatuses using a simulator have been proposed as operation support apparatuses in water treatment systems (facilities), these apparatuses are merely simulators obtained by simulating actual equipment, and are difficult to be said as apparatuses obtained by optimizing the actual equipment as a whole.

Therefore, in view of the problems of the recently used water treatment system 200, in the first embodiment, a water treatment system 1 will be described. The water treatment system 1 can achieve optimal automated operation of the water treatment system by controlling a water treatment process from the outside of actual equipment for the edge computer 40 by using machine learning, simulation, virtualizing technology, and the like.

Functional Configuration of Water Treatment System 1

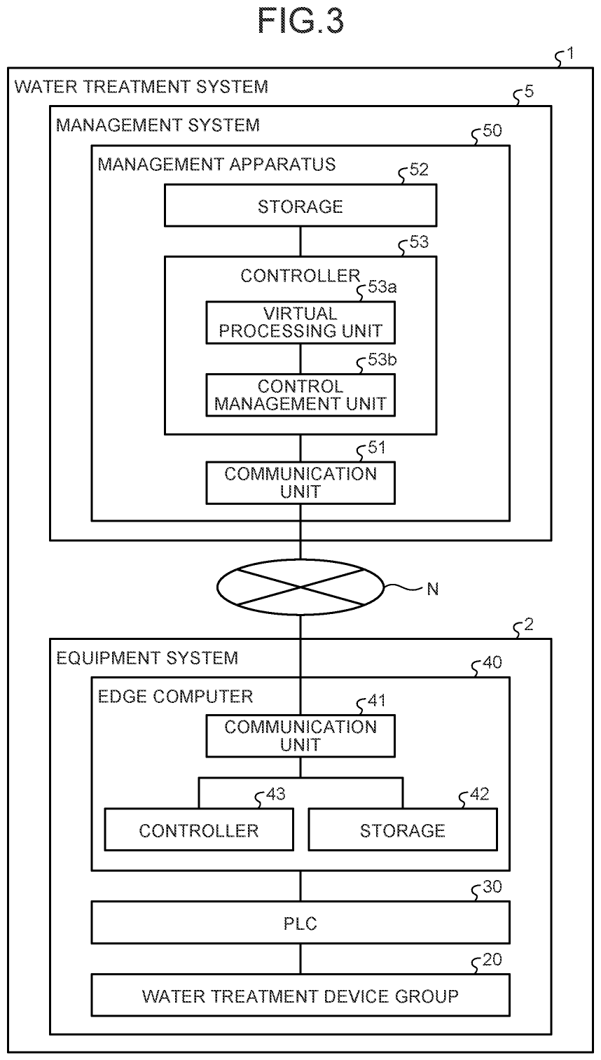

FIG. 3 is a functional block diagram illustrating a functional configuration of the water treatment system 1 according to the first embodiment. As illustrated in FIG. 3, the water treatment system 1 includes the equipment system 2 and the management system 5.

Configuration of Equipment System 2

The equipment system 2 executes a water treatment process, and includes the water treatment device group 20, the PLC 30, and the edge computer 40. The equipment system 2 does not have a hierarchized functional system configuration, but constitutes a module that performs minimum operation control including individual water treatment devices and the edge computer 40. This module can also be arranged and combined so as to be directly controlled by the management system 5 (plant-level-system and software).

The water treatment device group 20 includes water treatment devices that perform water treatment processes including filtration, disinfection, piping, calculation, and the like. For example, the water treatment device group 20 includes membranes UF-RO 20a, UJVAOP Ozone 20b, the mechanical components 20c, the control H&S 20d, and the like. Note that the individual water treatment devices can be freely arranged in a module by, for example, combining the devices in parallel or in series, or arranging a plurality of devices. Moreover, the module may include not only the water treatment device but an analysis device capable of performing sampling and analyzing water quality and performance.

The PLC 30 is one example of an apparatus that executes various commands and sequence control to each device in the water treatment device group 20. For example, the PLC 30 executes various types of control related to the water treatment process, such as change of water temperature, open/close control of a valve, and control of water amount, on each water treatment device in accordance with a logic including control (control logic) such as PID predetermined in an initial stage such as a design stage and an operation start stage of the water treatment system 1, and transmits the result (device information) to the edge computer 40.

Furthermore, the PLC 30 modifies, adds, changes, and deletes a logic and the like in accordance with an instruction from the edge computer 40 located at a higher level. Then, the PLC 30 executes various types of control, such as change of water temperature, open/close control of a valve, and control of a water amount, in accordance with the updated logic and the like.

The edge computer 40 is one example of an apparatus that executes operation control of the water treatment process in the equipment system 2 based on a result of operation of each water treatment device executed in control units of the water treatment process. The edge computer 40 includes a communication unit 41, a storage 42, and a controller 43.

The communication unit 41 is a processing unit that controls communication with other apparatuses, and is implemented by, for example, a communication interface and the like. For example, the communication unit 41 receives data related to a water treatment process such as a state and a control result from each water treatment device in the water treatment device group 20, and receives various pieces of data from the management apparatus 50. Furthermore, the communication unit 41 transmits various pieces of data including a control command and the like to the PLC30, and transmits various pieces of data on the water treatment process and various pieces of data on the control of the PLC 30 to the management apparatus 50.

The storage 42 is one example of a processing unit that stores various pieces of data, programs executed by the controller 43, and the like, and is implemented by, for example, a memory, a hard disk, and the like.

The controller 43 is a processing unit that controls the entire edge computer 40, and is implemented by, for example, a processor. Specifically, the controller 43 optimizes the water treatment process in the equipment system 2, to which the controller 43 belongs, by using device information on the operation status of each water treatment device in the equipment system 2, to which the controller 43 belongs.

Examples of the device information include information indicating whether or not each water treatment device is normally operating and information including the contents of treatment based on current set values (e.g., water amount, temperature, and open/close level of valve) for each water treatment device and the control contents about which an instruction has been given from the PLC 30 for each water treatment device.

Then, the controller 43 generates a first condition related to the water treatment process in the equipment system 2 based on each piece of device information. Thereafter, the controller 43 outputs processing execution, processing change, and the like to the PLC 30 in accordance with the first condition. Note that examples of the first condition include an operation condition that can be controlled in the equipment system 2, such as water quality, disinfection time, and a production amount, within a range of a specification in accordance with a condition of a client in the design stage of the equipment system 2 and the like.

In a specific example, the controller 43 acquires the status of the water treatment process, the operation status of each water treatment device, and the like from each water treatment device. Furthermore, the controller 43 acquires, from the PLC 30, a result of execution of a logic and the like performed by the PLC 30. Then, the controller 43 executes simulation or prediction using a machine learning model by using each piece of acquired data, and acquires a prediction result of a preliminarily designated item such as a state, a risk level, and a cost of the water treatment process. Thereafter, the controller 43, for example, changes the control contents for the PLC 30 in accordance with the prediction result.

More specifically, the controller 43 increases the opening degree of a valve in order to increase a production amount at the time when the production amount is predicted to decrease, or activates a temperature adjustment device in which alarm output of abnormally high temperature is predicted after several hours.

That is, the controller 43 (edge computer 40) can execute control for the optimized operation of the water treatment system 1 in order to maintain the production amount, reduce costs, and perform stable operation within a range of a specification predetermined at the time of designing the inside of the equipment system 2.

Furthermore, the controller 43 can also change or add a logic and the like of the PLC 30 by optimizing the water treatment process in the equipment system 2, to which the controller 43 belongs, in accordance with an instruction from the management system 5 (plant-level-system and software). For example, the controller 43 adds a logic and the like that increase a water amount for increasing the production amount. The controller 43 changes a threshold of a temperature abnormality, which has been set in an existing logic and the like, to a new threshold newly set on the side of the management system 5. The controller 43 reduces a part of the logic and the like for reducing costs.

That is, the controller 43 (edge computer 40) can also execute control for optimized operation of the water treatment system 1 beyond the range of the specification predetermined at the time of designing the inside of the equipment system 2 in accordance with an instruction of the management system 5 (plant-level-system and software). This is, however, merely one example, and the instruction from the management system 5 (plant-level-system and software) may be within the range of the specification predetermined at the time of designing the inside of the equipment system 2.

Configuration of Management System 5

As illustrated in FIG. 3, the management system 5 includes the management apparatus 50 implemented by a physical machine or a virtual machine. The management apparatus 50 includes a communication unit 51, a storage 52, and a controller 53.

The communication unit 51 is a processing unit that controls communication with other apparatuses, and is implemented by, for example, a communication interface and the like. For example, the communication unit 51 receives, from the edge computer 40, control contents from the PLC 30 and various pieces of data generated in the equipment system 2. Furthermore, the communication unit 51 transmits various pieces of data generated by the controller 53 to the edge computer 40.

The storage 52 is one example of a processing unit that stores various pieces of data, programs executed by the controller 53, and the like, and is implemented by, for example, a memory and a processor.

The controller 53 is a processing unit that controls the entire management apparatus 50, and is implemented by, for example, the processor. Specifically, the controller 53 includes a virtual processing unit 53a and a control management unit 53b, and executes operation control of the water treatment process in the equipment system 2 via the edge computer 40.

The virtual processing unit 53a acquires data on the operation status of the water treatment process in the equipment system 2 from the edge computer 40, and simulates the water treatment process by using each water treatment device virtualized by using the virtualizing technology and the acquired data. That is, the virtual processing unit 53a corresponds to the digital twin 50a in FIG. 1, and virtually constitutes a virtual system that simulates the same variation as that of the equipment system 2, which is actual equipment.

The control management unit 53b is a processing unit that controls a preprocessing process in the equipment system 2 via the edge computer 40. Specifically, the control management unit 53b corresponds to the AI engine 50b in FIG. 1. When, for example, a specification change of the equipment system 2, a request change, or a demand change of the total amount of generated water occurs, the control management unit 53b executes simulation using the virtual processing unit 53a. Then, the control management unit 53b executes change or the like of a logic and the like currently executed in the PLC 30 based on a simulation result.

For example, the control management unit 53b acquires process information on the operation status of the water treatment process from the edge computer 40 of the equipment system 2, and generates the control contents for optimizing the entire equipment system 2 based on the acquired process information. Then, the control management unit 53b outputs the control contents to the edge computer 40 of the equipment system 2. Note that examples of the process information include the control contents about which the edge computer 40 has given an instruction to the PLC 30, the execution status of the water treatment process executed based on the control contents, and the contents of simulation executed by the virtual processing unit 53a (digital twin 50a).

In one example of the optimization, the control management unit 53b can execute various predictions related to the water treatment process in the equipment system 2 by using a trained machine learning model and the like. For example, the control management unit 53b generates a second condition related to the water treatment process by using various pieces of data acquired, generated, and simulated by the virtual processing unit 53a (digital twin 50a). Then, the control management unit 53b notifies the edge computer 40 of the control contents in accordance with the second condition. As a result, the edge computer 40 executes change and the like of the control contents via the PLC 30.

Note that the second condition includes the operation contents and the like in accordance with information, which has been, for example, designated from the outside of the equipment system 2. For example, the control management unit 53b executes simulation by using the virtual processing unit 53a (digital twin 50a) when a specification change of a client occurs or improvement including costs and the like is proposed to the client outside the specification range of the equipment system 2. Thereafter, when the simulation result is permitted by the client or the like, the control management unit 53b outputs an instruction to change a logic and the like, the logic after the change, and the like to the edge computer 40 in accordance with the simulation result.

Flow of Processing

Next, one example of a flow of processing executed in the equipment system 2 and one example of a flow of processing executed in the management system 5 will be described.

Processing of Equipment System 2

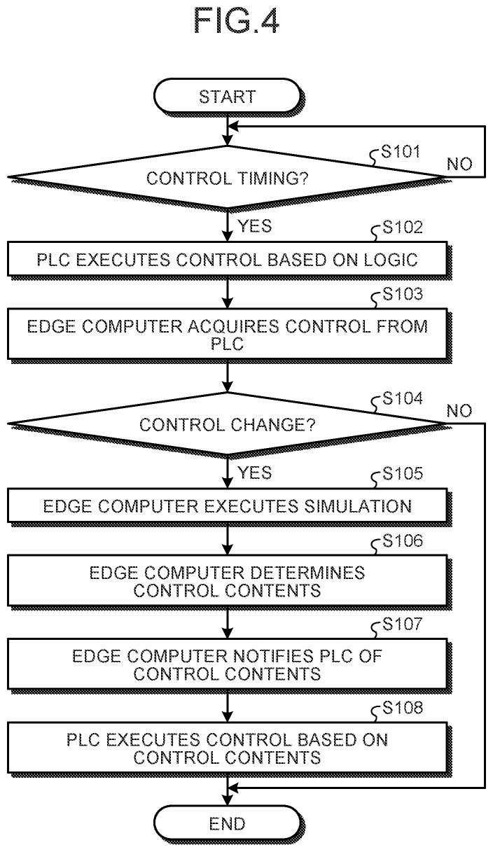

FIG. 4 is a flowchart illustrating a flow of processing executed by the equipment system 2. As illustrated in FIG. 4, when predetermined control timing is reached (S101: Yes), the PLC 30 controls the water treatment process based on a set logic and the like (S102). Then, the edge computer 40 acquires a control result from the PLC 30 (S103), detects the occurrence of abnormality detection, deviation from a normal value, and the like based on the control result from the PLC 30, and determines whether or not to change the control (S104).

Here, when determining that the control change is necessary (S104: Yes), the edge computer 40 executes simulation and the like (S105), and determines the control contents to be executed as a countermeasure (S106).

Then, the edge computer 40 notifies the PLC 30 of the control contents (S107). The PLC 30 executes change and the like of the set logic and the like based on the control contents about which notification has been made, and controls the water treatment process (S108).

Processing of Management System 5

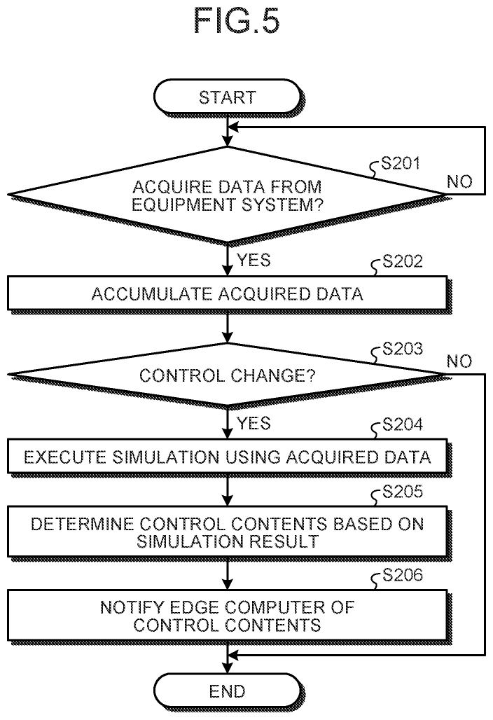

FIG. 5 is a flowchart illustrating a flow of processing executed by the management system 5. As illustrated in FIG. 5, when acquiring data of a state and a processing result related to the water treatment process from the equipment system 2 via the edge computer 40 (S201: Yes), the management system 5 accumulates the acquired data (S202).

Then, when a control change including a demand change, a setting change, a request change, abnormal circumstances, and the like occurs (S203: Yes), the management system 5 executes simulation using the virtual system of the water treatment process generated by the virtual processing unit 53a (digital twin 50a) by using the acquired data (S204).

Thereafter, the management system 5 determines the control contents for improving the water treatment process of the equipment system 2 and changing the design by using a table and the like in which the simulation result is associated with the design change and the like (S205).

Then, the management system 5 notifies the edge computer 40 of the equipment system 2 of the control contents (S206). As a result, the edge computer 40 executes logic change and the like of the PLC 30, and the PLC 30 executes processing with a new logic and the like, whereby a change of the water treatment process and the like is executed. Note that the management system 5 can also output the control contents generated by simulation and the like to the management apparatus, a display, and the like.

Effects

As described above, the water treatment system 1 according to the first embodiment can flexibly expand a module in response to a device expansion request in accordance with a demand. Since the water treatment system 1 can mutually divert data collected from individual water treatment devices used in various water treatment facilities without depending on the configuration of a water treatment device, the water treatment system 1 can achieve optimal control.

The water treatment system 1 can instantaneously calculate a module or combination to operate without depending on experiences and the like and automatically propose the module or combination by using the edge computer 40 and performing management at a module level. The water treatment system 1 can estimate an input/output value without testing actual equipment by simulating a method for addressing a sudden environmental variation on a virtual system in equipment with a little environmental variation.

### Second Embodiment

By the way, although, in the first embodiment, an example in which one edge computer 40 controls the entire water treatment device group 20 via the PLC 30 in the equipment system 2 has been described, this is not a limitation. For example, an edge computer can be installed for each water treatment device in the water treatment device group 20, and the management system 5 can control individual water treatment devices. Therefore, in a second embodiment, an example in which the management system 5 directly controls each water treatment device and a configured module in the actual equipment will be described.

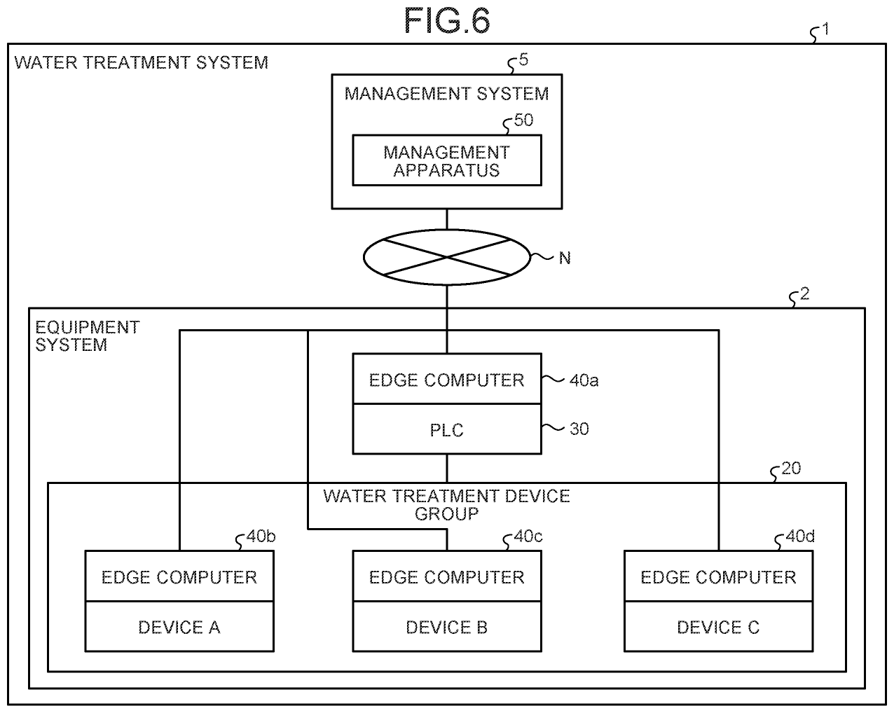

FIG. 6 illustrates the architecture of a water treatment system 1 according to the second embodiment. As illustrated in FIG. 6, the water treatment system 1 according to the second embodiment includes an equipment system 2 and a management system 5 as in the first embodiment.

The difference from the first embodiment is that edge computers 40a, 40b, 40c, and 40d are provided for the PLC 30, and each of a device A, a device B, and a device C of the water treatment device group 20 in the equipment system 2. Note that the edge computers 40a, 40b, 40c, and 40d have a function similar to that of the edge computer 40 described in the first embodiment.

For example, the management system 5 acquires data on the state of the PLC 30 or each water treatment device, the control status, the control result, and the like from each of the edge computers 40a, 40b, 40c, and 40d. Then, the management system 5 generates the control contents related to the operation of each water treatment device by using a virtual system, AI (machine learning model), and the like. Then, the management system 5 notifies each of the edge computers 40a, 40b, 40c, and 40d of the generated control contents.

As a result, each of the edge computers 40a, 40b, 40c, and 40d executes control in accordance with the control contents about which a notification has been given from the management system 5 for the PLC and each device. As described above, the management system 5 (AI engine 50b) directly controls the minimum unit of water treatment device in units of modules, whereby more optimal control can be performed at high speed.

Furthermore, since the management system 5 can obtain a solution that optimizes the entire processing system, an operation can be optimized in units of water treatment devices using each edge computer constituting a module, and modules can be combined. Furthermore, since the management system 5 can directly send a command to the water treatment device, speed of operation to the water treatment device is improved. Furthermore, it is possible to improve the degree of freedom of combination of water treatment devices, improve the degree of freedom of combination of parameters, and consider a causal relation between terminal devices. The management system 5 can quickly and appropriately derive a countermeasure for an unexpected variation.

### Third Embodiment

By the way, although, in the first embodiment and the second embodiment, an example in which one management system 5 manages and controls one water treatment system (equipment system 2) has been described, this is not a limitation. For example, the entire water treatment system can be controlled from a higher perspective by one management system 5 managing an integrated system obtained by combining a plurality of water treatment devices as one water treatment device.

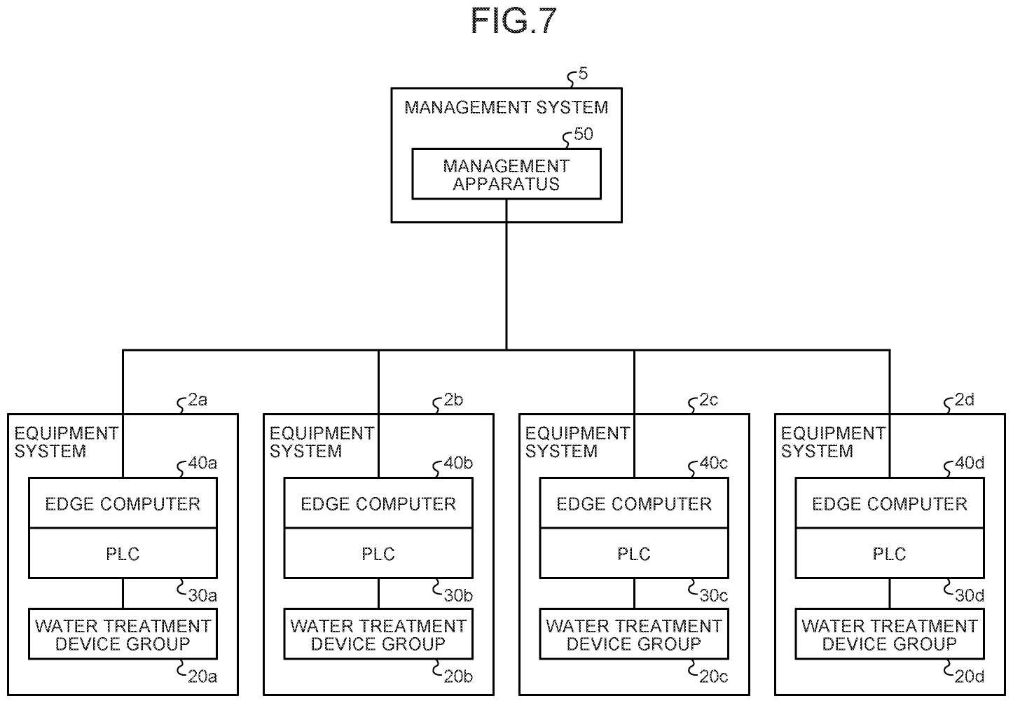

FIG. 7 illustrates the architecture of a water treatment system 1 according to a third embodiment. As illustrated in FIG. 7, the water treatment system 1 according to the third embodiment includes a management system 5 and a plurality of equipment systems 2a, 2b, 2c, and 2d.

Here, the management system 5 has a function similar to that of the management system 5 described in the first embodiment. Each of the equipment systems 2a, 2b, 2c, and 2d has a function similar to that of the equipment system 2 described in the first embodiment.

Furthermore, an equipment system 2a includes a water treatment device group 20a, a PLC 30a, and an edge computer 40a. An equipment system 2b includes a water treatment device group 20b, a PLC 30b, and an edge computer 40b. Furthermore, an equipment system 2c includes a water treatment device group 20c, a PLC 30c, and an edge computer 40c. An equipment system 2d includes a water treatment device group 20d, a PLC 30d, and an edge computer 40d.

Note that, the water treatment device groups 20a, 20b, 20c, and 20d have a configuration similar to that of the water treatment device group 20 described in the first embodiment. The PLCs 30a, 30b, 30c, and 30d have a function similar to that of the PLC 30 described in the first embodiment. The edge computers 40a, 40b, 40c, and 40d have a function similar to that of the edge computer 40 described in the first embodiment.

In such configuration, the management system 5 collects data not only from one water treatment system but from a plurality of water treatment systems. For example, the management system 5 acquires various pieces of data on the water treatment process from each of the equipment systems 2a, 2b, 2c, and 2d. Then, the management system 5 generates the control contents related to an integrated operation index of a plurality of equipment systems based on the operation status and the like of the water treatment process of each of the plurality of equipment systems. Thereafter, the management system 5 executes operation control of the water treatment process executed by each edge computer of each equipment system in accordance with the control contents.

For example, a water treatment system in which each equipment system 2 is installed in the same region is assumed. In this state, even when an instruction to increase a production amount of the entire system is given, the management system 5 can make a change to the control contents for improving the operation rate of the equipment system 2b having a production amount to spare. As a result, the management system 5 can increase the production amount by distributing a load of the entire water treatment system, so that a risk accompanying stop of any water treatment system can be avoided.

Furthermore, in the above-described state, even when an instruction to increase the production amount of the equipment system 2a is given, the management system 5 can make a change to the control contents for improving the operation rate of the equipment system 2c having the lowest operation costs. As a result, the management system 5 can increase the production amount while reducing the costs of the entire water treatment system.

Furthermore, the management system 5 can collect and integrally manage the operation status, capital investment, costs, and the like of each equipment system 2. As a result, when a certain equipment system has an abnormally high operation load, the management system 5 can also propose a client to use another equipment system.

Furthermore, the management system 5 manufactures the equipment system 2a and the equipment system 2b that satisfy a request from the client, and executes the water treatment process. Thereafter, even when the need to generate a new equipment system arises in association with a request change from the client, the management system 5 can respond to the request from the client while reducing the costs of generating the new system by proposing use of the equipment system 2d having the same configuration.

As described above, in the water treatment system 1 according to the third embodiment, data collected from a plurality of water treatment systems can be mutually diverted and optimization can be achieved not in association with individual water treatment systems (equipment systems).

### Fourth Embodiment

Although the embodiments of the present invention have been described so far, the present invention may be implemented in various different forms other than the above-described embodiments.

Numerical Value and the Like

The number of water treatment devices, the number of equipment systems, specific examples of control contents, and the like described in the above-described embodiments are merely examples, and can be optionally changed. Furthermore, in the flowcharts described in the embodiment, the order of processing can be changed within a range without contradiction.

System

Information including the processing procedures, the control procedures, the specific names, and various pieces of data and parameters in the above document and the drawings can be optionally changed unless otherwise specified. For example, the water treatment system 1 may be configured such that actual equipment automatically simulates an optimized virtual system configuration calculated by the management system 5 (plant-level-system and software).

Furthermore, each component of each illustrated apparatus is functionally conceptual, and is not necessarily required to be physically configured as illustrated. That is, a specific form of distribution and integration of each apparatus is not limited to the illustrated form. That is, all or a part thereof can be functionally or physically distributed and integrated in any unit in accordance with various loads, use status, and the like.

Moreover, all or any part of each processing function performed in each apparatus can be implemented by a central processing unit (CPU) and a program analyzed and executed by the CPU, or can be implemented as hardware using a wired logic.

Hardware

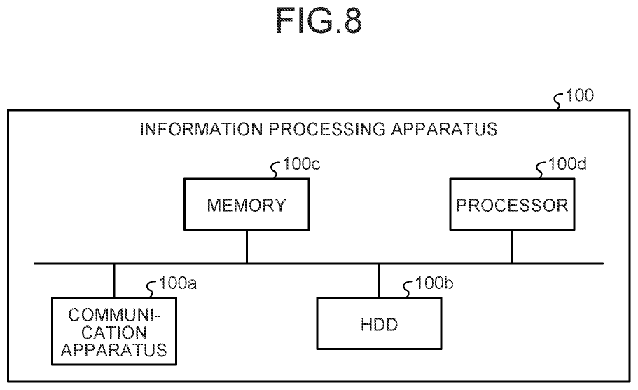

Next, an example of hardware configurations of the computers described in the embodiments will be described. Note that, since the management apparatus 50 and the edge computer 40 have similar hardware configurations, the management apparatus 50 and the edge computer 40 will be described as an information processing apparatus 100. FIG. 8 illustrates an example of the hardware configuration. As illustrated in FIG. 8, the information processing apparatus 100 includes a communication apparatus 100a, a hard disk drive (HDD) 100b, a memory 100c, and a processor 100d. Furthermore, the units in FIG. 8 are connected to each other by a bus or the like.

The communication apparatus 100a is a network interface card or the like, and communicates with another server. The HDD 100b stores a program for operating the functions in FIG. 3 and a DB.

The processor 100d reads a program for executing processing similar to those of the processing units in FIG. 3 from the HDD 100b or the like, and develops the program in the memory 100c. The processor 100d thereby operates a process for executing each function described with reference to FIG. 3 and the like. For example, when described by taking the management apparatus 50 as an example, the process executes a function similar to that of each processing unit of the management apparatus 50. Specifically, the processor 100d reads a program having functions similar to those of the virtual processing unit 53a, the control management unit 53b, and the like from the HDD 100b and the like. Then, the processor 100d executes a process of executing processing similar to those of the virtual processing unit 53a, the control management unit 53b, and the like.

As described above, the information processing apparatus 100 operates as an information processing apparatus that executes a water treatment method by reading and executing the program. Furthermore, the information processing apparatus 100 can also implement a function similar to those of the above-described embodiments by reading the above-described program from a recording medium with a medium reading apparatus and executing the read program. Note that the program in the other embodiments is not limited to being executed by the information processing apparatus 100. For example, the present invention can be similarly applied even to a case where another computer or server executes a program or a case where these computer and server execute the program in cooperation.

The program can be distributed via a network such as the Internet. Furthermore, the program is recorded in a computer-readable recording medium such as a hard disk, a flexible disk (FD), a CD-ROM, a magneto-optical (MO) disk, and a digital versatile disc (DVD), and can be executed by being read from the recording medium by the computer.

According to one embodiment, optimal automated operation of a water treatment system can be achieved.

What is claimed is:

1. A water treatment system comprising:
an equipment system including each water treatment device that executes a water treatment process and a control apparatus that controls each water treatment device; and
a management system including a management apparatus that determines a control content of the water treatment process by using a virtual system obtained by virtualizing each water treatment device and controls the water treatment process of the equipment system based on the control content via the control apparatus of the equipment system.

2. The water treatment system according to claim 1,
wherein the water treatment system includes a plurality of equipment systems each including each water treatment device and the control apparatus, and
each control apparatus of the plurality of equipment systems includes a controller that optimizes the water treatment process in the equipment system to which each control apparatus belongs by using device information on an operation status of each water treatment device in the equipment system to which each control apparatus belongs.

3. The water treatment system according to claim 2,
wherein the management apparatus of the management system includes a controller that:
acquires process information on an operation status of the water treatment process from each control apparatus of each of the plurality of equipment systems,
generates a control content that optimizes a whole of the plurality of equipment systems based on the process information of each of the plurality of equipment systems, and
outputs the control content to each control apparatus of the plurality of equipment systems, and
each control apparatus of the plurality of equipment systems optimizes the water treatment process in the equipment system to which each control apparatus belongs in accordance with the control content that has been output from the control apparatus.

4. The water treatment system according to claim 1,
wherein the equipment system includes the control apparatus for each water treatment device, and
the management apparatus of the management system includes a controller that executes operation control of each water treatment device via each control apparatus.

5. The water treatment system according to claim 1,
wherein the management apparatus includes a controller that:
acquires process information on an operation status of the water treatment process from the control apparatus;
executes simulation of the water treatment process by using the virtual system and the process information; and
controls the water treatment process based on a result of the simulation via the control apparatus.

6. A water treatment method to be executed by a water treatment system including an equipment system and a management system, the water treatment method comprising:
executing operation control of each water treatment device that executes a water treatment process, using a control apparatus of the equipment system;
determining a control content of the water treatment process by using a virtual system obtained by virtualizing each water treatment device; and
controlling the water treatment process of the equipment system based on the control content via the control apparatus of the equipment system, using a management apparatus of the management system.

7. An information processing apparatus comprising a controller that:
generates a virtual system obtained by virtualizing each water treatment device that executes a water treatment process in an equipment system;
determines a control content of the water treatment process by using the virtual system; and
controls the water treatment process of the equipment system based on the control content via a control apparatus that controls each water treatment device that executes the water treatment process in the equipment system.
